(19) United States
(12) Patent Application Publication
(10) Pub. No.: US 2008/0233237 A1
(43) Pub. Date: Sep. 25, 2008

(54) Method of Producing a Solid Seasoning Using Liquid Culture of Kojic Mold From Plant Protein Source, a Solid Seasoning Produced From the Same, a General Food Seasoning, Sauce, Dressing, Soysauce, and Processed Food

(75) Inventors: Jae-Young Han, Seoul (KR); Eun-Seol Kim, Seoul (KR); Jun-Bong Choi, Seoul (KR); Hyun Chi, Seoul (KR); Seong-Jun Cho, Seoul (KR); Hee-Nam Yoon, Seoul (KR)

Correspondence Address: CANTOR COLBURN, LLP, 20 Church Street, 22nd Floor, Hartford, CT, 06103, US

(73) Assignee: CJ CHEILJEDANG CORP., Seoul (KR)

(21) Appl. No.: 12/064,750

(22) PCT Filed: Aug. 24, 2006
(86) PCT No.: PCT/KR06/03337

§ 371 Date: May 2, 2008

(30) Foreign Application Priority Data
Aug. 24, 2005 (KR) 10-2005-0078007

(51) Int. Cl. A23L 1/22; A23L 1/227

(52) U.S. Cl. 426/46; 426/52; 426/656; 426/589; 426/650

(57) ABSTRACT

Provided are a method of producing a solid seasoning including: mixing at least one plant protein source selected from the group consisting of sterilized soy beans, non-fat soy beans and wheat gluten, and a liquid culture medium of kojic mold, and degrading the plant protein source under unsalted and sterile conditions; and drying the degraded product to obtain the solid seasoning, a solid seasoning produced using the method, and a general food seasoning, sauce, dressing, soy sauce or soy bean paste, or processed food including the solid seasoning.

### TECHNICAL FIELD

The present invention relates to a method of producing a solid seasoning using a liquid culture of kojic mold from plant protein sources, a solid seasoning produced using the method, and a general food seasoning, sauce, dressing, soy sauce or soy bean paste, or processed food including the solid seasoning.

### BACKGROUND ART

Monosodium glutamate (MSG) is generally used to improve the flavor of a variety of foods. Since MSG was fist extracted from an ocean plant called “sea tangle” in 1908 by Dr. Ikeda of Japan, nucleotide ingredients such as sodium inosinate and sodium guanylate have been identified as flavor enhancers to provide foods with a savory taste.

Demands for high quality and refined taste of food have been growing with economic developments, and consumers demand more “ripened” and “enriched” flavor than the savory taste in foods. Such ripened and enriched flavor is called “gokumi” in Japan and “deep taste” or “rich flavor” in Korea.

Typically, sufficiently fermented or ripened soy bean paste or soy sauce can be used to give such rich flavor to foods. The taste of peptides and amino acids in the soy sauce and soy bean paste is considered to act a main role in providing the rich flavor, and the peptides and amino acids are generated through the degradation of wheat or soy bean protein by protease of kojic mold in a high concentration of salt for a long period of time.

Soy bean paste and soy sauce are produced using traditional methods for long term storage of agricultural products and using traditional methods of producing seasoning. The methods of producing soy bean paste and soy sauce are well known in the art. Plenty of patent applications applying such methods have been filed. In addition, a method of using a commercially available protease to obtain peptides and amino acids from proteins is described in Korean Patent Laid-Open Gazette No. 1998-0200076. However, according to this method there are limitations in the manufacturing costs and the quality of taste.

A method of degrading proteins using kojic mold as an enzyme source is disclosed in Japanese Patent Publication Nos. 2004-201678 and 2003-289826, and a method of degrading proteins using kojic mold extract is disclosed in Japanese Patent Publication No. 1993-084050. However, the kojic mold treatment is complex, and generally a great quantity of salt or alcohol must be added to prevent contamination from various microorganisms. Such additives inhibit the activity of enzymes, and thus the degradation of protein takes longer. Further, a great quantity of salt inhibits products from being generally used.

A method of using liquid kojic mold has also been introduced. For example, Japanese Patent Publication No. 2004-313113 discloses a method of producing seasoning by adding liquid kojic mold to extraction residues of dired fish and degrading the extraction residues of dired fish at a temperature of 50° C. or higher while the concentration of alcohol is maintained in the range of 2 to 5%. However, according to this method, the degradation of plant protein sources using a liquid kojic mold is performed in an open system, for example an open system in which a stirrer is covered with plastic wrap, and thus the reaction solution may be contaminated by various microorganisms. In this method, 2 to 5% of alcohol is added to the reaction solution to lessen or prevent such contamination, and the degradation is performed at a temperature of 50° C. or higher to reduce the amount of nonvolatile amines such as tyramine and histamine.

A method of producing a peptide-containing solid seasons by degrading a plant protein source using a pure culture of kojic mold without additives such as alcohol preventing contamination from various microorganisms has not been reported.

### DETAILED DESCRIPTION OF THE INVENTION

### Technical Problem

The present invention provides a method of producing a solid seasoning having excellent savory taste and long taste duration by reacting a plant protein source with a liquid culture medium of kojic mold at a low temperature without contamination from microorganisms.

The present invention also provides a solid seasoning produced using the method.

The present invention also provides a general food seasoning including the solid seasoning.

The present invention also provides a sauce, dressing, soy sauce or soy bean paste, or processed food including the solid seasoning.

### Technical Solution

According to an aspect of the present invention, there is provided a method of producing a solid seasoning including: mixing at least one plant protein source selected from the group consisting of sterilized soy beans, non-fat soy beans and wheat gluten, and a liquid culture medium of kojic mold, and degrading the plant protein source under unsalted and sterile conditions; and drying the degraded product to obtain the solid seasoning.

The kojic mold may be Aspegillus oryzae or Aspegillus sojae, but is not limited thereto. Any culture medium can be used for culturing the kojic mold as long as the culture medium does not include salt, i.e., sodium chloride. The culture medium may include non-fat soy beans. The temperature at which the kojic mold is cultured is not limited as long as the kojic mold can grow and produce enzymes such as peptidase and may be in the range of 25 to 35° C.

The plant protein source may be sterilized soy beans, non-fat soy beans or wheat gluten. The wheat gluten contains plenty of glutamines and acts a main role in savory taste of soy sauce and soy bean paste. Soy beans or non-fat soy beans are useful as an ingredient to provide a savory taste and rich flavor. The plant protein source may have a mean grain size of between 10 μm and 1 mm, and preferably between 50 and 250 μm.

The plant protein source may be prepared by eliminating air in the plant protein source. The process of eliminating air can be performed using a method that is commonly used in the art. For example, the air can be eliminated by treating the plant protein source in a vacuum or substituting air in the plant protein source with nitrogen. Accordingly, bubbles which may generate in a solution including the plant protein source can be prevented by eliminating air. In addition, the bubbles are known to inhibit sterilization, and thus sterilization can be more effectively performed by eliminating air.

The liquid culture medium of kojic mold can be prepared by culturing the kojic mold of Aspergillus oryzae or Aspergillus sojae in a liquid culture medium containing 0.5 to 3.0% of sterilized non-fat soy beans, 0.1 to 1.5% of yeast extract, 0.5 to 2.5% of glucose, 0.1 to 1.0% potassium phosphate, 0.01 to 0.1% of magnesium sulfate, and the remaining percent of water.

The method of producing a solid seasoning may further include inactivating enzymes by heating the degraded product at a temperature in the range of 80 to 100° C. for 10 to 40 minutes after degrading the plant protein source. Through such heat treatment, uniform products can be produced by inactivating enzyme activities and also various microorganisms which can be accidentally added to the reaction solution can be sterilized.

In addition, the method of producing a solid seasoning may further include filtering the degraded product after inactivating enzymes. Through such filtering, solid components in the degraded product can be removed and various microorganisms can be eliminated.

The process of degrading the plant protein source may be performed at a temperature in the range of 20 to 50° C. for 6 hours to 7 days, and preferably 1 to 5 days. The time required for the protein degradation may vary according to the titer of enzymes in the liquid culture medium, plant protein sources, etc., and be also properly controlled to a desired level according to a seasoning to be obtained.

In the method, the protein degradation is characterized by being performed under sterile and substantially unsalted conditions. If the protein degradation is performed under high salt conditions, enzymes in the kojic mold are low resistant to salt, and thus activities of the enzymes are inhibited to elongate the reaction time. When a substrate such as soy beans is degraded under non-sterile conditions to produce soy bean paste and soy sauce, generally at least 10% of salt is included, and thus it usually takes several months to over one year to degrade and ripen plant protein sources. In addition, plenty of salt included in products could limit the range of use of the products. Thus, the protein degradation in an embodiment of the present invention is performed under salt-free conditions to overcome this problem.

In plant protein sources, swelling and gelation can easily occur during sterilization, and thus substantial sterilization cannot easily be obtained, and this can be more serious as the concentration of protein is increased.

In the method, protein powder having a mean grain size of between 10 μm and 1 mm, and preferably between 50 and 250 μm is used to facilitate the heat transfer within the protein powder during the sterilization. In addition, air in a solution containing plant protein source is eliminated by substituting the air with nitrogen by injecting minute nitrogen bubbles into the solution before the sterilization, or treating the solution in a vacuum in order to prevent bubbles which may generate while a high concentration protein is sterilized. Particularly, injecting nitrogen becomes more important as the scale of process increases. A lump of protein which could inhibit the sterilization is easily formed in a stationary sterilization, and thus the sterilization is performed while stirring or a continuous sterilizer is used. In order to prevent a microbial contamination due to the inflow of external air during the protein degradation, positive pressure is maintained in the culture medium. Accordingly, the protein degradation can be performed without adding salt since a contamination from various microorganisms is not expected in the culture solution.

FIG. 1 is a flow chart illustrating a method of producing a solid seasoning according to an embodiment of the present invention.

The solid seasoning produced according to the method of the present invention has high concentrations of amino acids and peptides, and the solid seasoning with low salt concentration can be rapidly produced without the contamination from various microorganisms. Particularly, the solid seasoning is characterized by having a high concentration of peptides.

Thus, according to another aspect of the present invention, there is provided a solid seasoning including 15 to 45% of peptides based on the total weight of the dried solid seasoning.

The solid seasoning of the present invention has an excellent savory taste. Sensory evaluation on the obtained solid seasoning was performed as follows. First, the amount of glutamic acid in the solid seasoning was analyzed and the concentration of the solid seasoning was diluted to 0.03% which is the threshold of sodium glutamate. The sensory evaluation of the diluted solid seasoning solution was performed based on the 0.03% of sodium glutamate. When the savory taste of sample solutions is much stronger than the 0.03% of sodium glutamate, the sample solutions are further diluted to have a savory taste level similar to that of 0.03% of sodium glutamate. The sensory evaluation was performed by 10 trained panelists.

According to another aspect of the present invention, there is provided a general food seasoning including the solid seasoning as an effective ingredient. Such general food seasoning may further include a filler, a diluent, or the like that are commonly used in the art in addition to the solid seasoning.

The general food seasoning may have a certain form, for example may be liquefied or granulated seasonings.

According to another aspect of the present invention, there is provided a sauce, dressing, soy sauce and soy bean paste, or processed food including the solid seasoning.

### Advantageous Effects

In a method of producing solid seasoning according to the present invention, a solid seasoning having properties of low salt concentration, excellent savory taste, and long taste duration can be rapidly produced without contamination from various microorganisms.

The solid seasoning, general food seasoning, sauce, dressing, soy sauce, and processed food produced according to the present invention have excellent savory taste and long taste duration.

### DESCRIPTION OF THE DRAWINGS

The above and other features and advantages of the present invention will become more apparent by describing in detail exemplary embodiments thereof with reference to the attached drawing in which:

FIG. 1 is a flowchart illustrating a method of producing a solid seasoning according to an embodiment of the present invention.

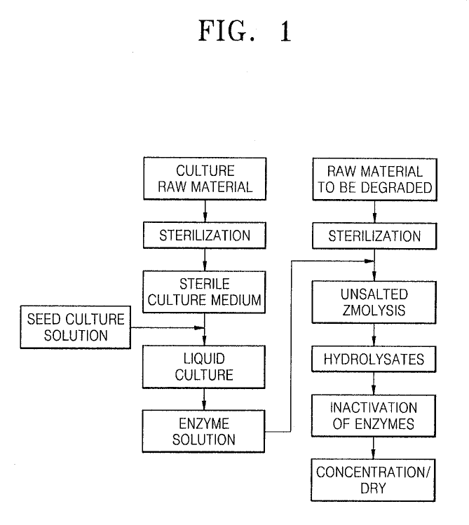

### MODE OF THE INVENTION

Hereinafter, the present invention will now be described in more detail. The invention may, however, be embodied in many different forms and should not be construed as being limited to the embodiments set forth herein; rather, these embodiments are provided so that this disclosure will be thorough and complete, and will fully convey the concept of the invention to those skilled in the art. Hereinafter, the term “%” indicates % by weight unless otherwise stated.

### EXAMPLES

### Example 1

### Zymolysis of Non-fat Soy Beans under Unsalted and Sterile Conditions—Selecing Optimized Grain Size of the Non-fat Soy Beans

2 g of non-fat soy beans, 2 g of yeast extract, 4 g of glucose, 0.6 g of potassium phosphate, 0.1 g of magnesium sulfate, and 2 l of distilled water were added to 5 l of a culture vessel, and the culture medium was autoclaved at a temperature of 120° C. for 30 minutes.

Spores of pure cultured Aspergillus sojae were inoculated into the obtained autoclaved culture medium, and the culture medium was cultured 1/1 vvm under airtight conditions to prevent contamination from various microorganisms at 500 rpm at 30° C. for 36 hours to obtain 300 U/mL of an enzyme solution having protease activity. The enzymetic activity of the culture medium was measured using a substrate formed of casein at 30° C.

Sample solutions were prepared by altering the mean grain size of the non-fat soy beans to evaluate the influence of the grain size of the non-fat soy beans which were used as substrates. Four types of non-fat soy beans were prepared. Aqueous Solutions respectively having unpulverized non-fat soy beans, and non-fat soy beans having grain sizes of 2 mm, 1 mm and 250 μm were prepared at a concentration of 20%, and each of the solutions were sterilized while stirring in a 5 l stainless steel culturevessel. 200 ml of each sterilized substrate was placed in a 1 l sterilized flask, and 50 ml of each culture solution was added thereto under sterile conditions, and the mixture was incubated for zymolysis under airtight conditions and weak stirring at a temperature in the range of 40 to 45° C. for 72 hours. Hyphae in the culture solution were used together with the culture solution without filtering and crushing processes, and protease which was inside the hyphae or bound to the cell walls of the hyphae was freed to participate in protein hydrolysis. Each of the protein hydrolysates was heated at 85° C. for 20 minutes to inactivate enzymes, the resultant was cooled, and supernatant was obtained by centrifuging at 6,000 rpm for 20 minutes. Nasty smells of these supernatants, caused by microbial contamination, etc. were evaluated by panelists, and the results are shown in Table 1.

TABLE 1

| Grain size (mean) | Unpulverized | 2 mm | 1 mm | 250 μm |
|---|---|---|---|---|
| Sensory | Strong | Strong | Weak | No |
| characteristics | nasty | nasty | nasty | nasty |
| | smell | smell | smell | smell |

As shown in Table 1, successful sterilization can be obtained when the grain size of the non-fat soy beans which are used as a substrate is less than 1 mm. Accordingly, substrates having a mean grain size of 1 mm or less were used in Examples 2 to 4, and the minimum grain size was adjusted to 10 μm to facilitate the filtering process.

### Example 2

### Preparation of a Pilot Scale of Powdered Seasoning from Non-fat Soy Beans

150 l of 3% by weight of non-fat soy beans, 1.5% by weight of yeast extract, 1.5% by weight of glucose, 0.5% by weight of potassium phosphate, and 0.05% by weight of magnesium sulfate were added to a 500 l stainless steel culturevessel, and the culture medium was autoclaved at a temperature of 120° C. for 20 minutes. Spores of pure cultured Aspergillus sojae were inoculated into the obtained autoclaved culture vessel, and the culture medium was cultured at 1/2 vvm under airtight conditions to prevent contamination from various microorganisms at 300 rpm at 30° C. for 70 hours to obtain 200 U/mL of an enzyme solution having protease activity.

20% of non-fat soy bean powder solution was prepared in another stainless steel vessel, and nitrogen gas was injected thereto while stirring. The substitution in the protein solution was measured using a DO meter, and the substitution was considered to be completed when the maximum saturated oxygen concentration was in the range of 0 to 5%. The prepared solution was sterilized while stirring at 100 rpm at 120° C. for 0.5 hours, and cooled to a temperature of 40° C. 150 l of enzyme solution was mixed with the cooled non-fat soy bean solution in the culture solution under sterile conditions, and the reaction was performed at 43° C. for 120 hours while sterilized air was injected to the culture solution to set the inside pressure of the stainless steel vessel to 0.1 atmospheric pressure. The reacted solution was heated at 90° C. for 30 minutes to inactivate enzymes, the resultant was filtered with a 0.1 μm filter membrane, the filtered solution was concentrated in a vacuum, and the concentrated solution was granulated using a Brix 40 fluid bed dryer. As a result, yellowish brown granules having enriched flavor consisting of 8.7% of nitrogen, 32.6% of peptides, and 3.5% of glutamic acid based on the total weight of the dried resultant were obtained. The degree of hydrolysis was calculated by the ratio of amino-nitrogen content to the total nitrogen, and the amount of peptides was calculated by subtracting the total amount of amino acids from the total amount of proteins (the total amount of nitrogen×6.25).

The obtained granules were diluted to a glutamic acid concentration of 0.03%, and the diluted solution was prepared as a sample solution. 0.03% glutamic acid was used as the control solution. The taste of the diluted solutions was evaluated by ten panelists by comparing the tastes between the sample solutions and the control solution. As a result, the sample solution produced according to Example 2 of the present invention had strong savory taste and long taste duration.

### Example 3

### Sensory Evaluation

The sample solution produced in Example 2 was diluted again to prepare another sample solution. The number of panelists who answered that the savory taste of the sample solution produced according to Example 3 of the present invention was the same as that of the sample solution produced according to Example 2 was counted, and the results are shown in Table 2.

TABLE 2

| Dilution (fold) | 2 | 4 | 6 | 8 | 10 | 12 |
|---|---|---|---|---|---|---|
| No. of panelists | 0 | 1 | 4 | 3 | 2 | 0 |

The average strength of the savory taste was calculated by multiplying each dilution fold by the number of the panelists and dividing the resultant by the total number of panelists. In Table 2, the average strength was 7.2 times of sodium glutamate ((4×1+6×4+8×3+10×2)/10=7.2).

When the taste duration (time required until the taste of the sample solution vanished) was measured in the same manner as described above, the dilution fold was increased due to long durability of the taste. The results are shown in Table 3.

TABLE 3

| Dilution (fold) | 3 | 6 | 9 | 12 | 15 | 18 |
|---|---|---|---|---|---|---|
| No. of panelists | 0 | 0 | 0 | 3 | 6 | 1 |

The average taste duration was 14.4 times that of sodium glutamate.

### Example 4

### Preparation of Mass Production Scale of Powdered Seasoning from Non-fat Soy Beans

60 kg of non-fat soy beans, 15 kg of yeast extract, 60 kg of glucose, 46 kg of potassium phosphate, and 1.5 kg of magnesium sulfate were dissolved in 2400 l of distilled water in a 3000 l stainless steel culture vessel, and the culture medium was autoclaved at a temperature of 125° C. for 30 minutes and cooled to a temperature of 50° C. Then the culture medium was further sterilized at 120° C. for 30 minutes next day and cooled to a temperature of 30° C. Aspergillus sojae was pre-cultured in a 15 l culture vessel including 10 l of sterile culture solution consisting of the same as components above at 30° C. for 24 hours. Then the culture solution was added to the 3000 l stainless steel culture vessel under sterile conditions and further cultured at 350 rpm at 1/2 vvm at a temperature in the range of 30 to 32° C. for 30 hours. The enzymetic activity in the final culture solution was 600 U/mL.

Meanwhile, 7 kl of 30% of non-fat soy beans sterilized solution (sterilized through continuous convection at 120° C. for 30 minutes using a tube type heat exchanger after nitrogen substitution) was reacted at 45° C. for 60 hours in a 10 kl stainless steel culture vessel. The inside pressure was set at 0.2 atmospheric pressure to prevent microbial contamination due to the inflow of external air. The reaction solution was heated in a continuous convection heater at 90° C. for 20 minutes, cooled to 50° C., and filtered using a filter press. The filtered solution was passed through a 0.5 μm filter membrane, concentrated using a Brix 40, adding dextrin as a filler to the concentrated solution up to 30%, and spray-dried to prepare yellowish seasoning powder. The seasoning powder consisted of 6.8% of nitrogen, 21.7% of peptides, and 3.4% of glutamic acid based on the total weight of the dried seasoning powder.

According to the present invention, a solid seasoning having excellent properties can be easily produced from plant protein sources by using non-fat soy beans having a mean grain size of 1 mm to 10 μm, substituting air in a solution with nitrogen and sterilizing while stirring the solution to prevent lumping, and maintaining positive pressure during the protein degradation to prevent contamination from various microorganisms to degrade plant protein sources under sterile conditions.

1. A method of producing a solid seasoning comprising:
mixing at least one plant protein source selected from the group consisting of sterilized soy beans, non-fat soy beans and wheat gluten,
and a liquid culture medium of kojic mold, and degrading the plant protein source under unsalted and sterile conditions; and
drying the degraded product to obtain the solid seasoning.

2. The method of claim 1, wherein the liquid culture medium of kojic mold is prepared by culturing a kojic mold selected from the group consisting of Aspergillus oryzae and Aspergillus sojae in a liquid culture medium comprising 0.5 to 3.0% of sterilized non-fat soy beans, 0.1 to 1.5% of yeast extract, 0.5 to 2.5% of glucose, 0.1 to 1.0% potassium phosphate, 0.01 to 0.1% of magnesium sulfate, and the remaining percent of water.

3. The method of claim 1, further comprising inactivating enzymes by heating the degraded product at a temperature in the range of 80 to 100° C. for 10 to 40 minutes after degrading the plant protein source.

4. The method of claim 3, further comprising filtering the degraded product after inactivating enzymes.

5. The method of claim 1, wherein the process of degrading the plant protein source is performed at a temperature in the range of 20 to 50° C. for 6 hours to 7 days.

6. The method of claim 1, wherein the plant protein source has a mean grain size of between 10 μm and 1 mm.

7. The method of claim 1, wherein the plant protein source is prepared by eliminating air in the plant protein source.

8. The method of claim 7, wherein the eliminating air is performed by treating the plant protein source in a vacuum or substituting air in the plant protein source with nitrogen.

9. A solid seasoning produced using the method of claim 1, comprising 15 to 45% of peptides based on the total weight of the dried solid seasoning.

10. A general food seasoning comprising the solid seasoning of claim 9 as an effective ingredient.

11. A sauce, dressing, soy sauce or soy bean paste, or processed food comprising the solid seasoning of claim 9.

12. A solid seasoning produced using the method claim 2, comprising 15 to 45% of peptides based on the total weight of the dried solid seasoning.

13. A solid seasoning produced using the method of claim 3, comprising 15 to 45% of peptides based on the total weight of the dried solid seasoning.

14. A solid seasoning produced using the method of claim 4, comprising 15 to 45% of peptides based on the total weight of the dried solid seasoning.

15. A solid seasoning produced using the method of claim 5, comprising 15 to 45% of peptides based on the total weight of the dried solid seasoning.

16. A solid seasoning produced using the method of claim 6, comprising 15 to 45% of peptides based on the total weight of the dried solid seasoning.

17. A solid seasoning produced using the method of claim 7, comprising 15 to 45% of peptides based on the total weight of the dried solid seasoning.

18. A solid seasoning produced using the method of claim 8, comprising 15 to 45% of peptides based on the total weight of the dried solid seasoning.
